(19) United States
(12) Patent Application Publication
(10) Pub. No.: US 2003/0118075 A1
(43) Pub. Date: Jun. 26, 2003

(54) Optical temperature sensor

(76) Inventors: Gustav Schweiger, Duisburg (DE); Frank Janetta, Bottrop (DE)

Correspondence Address: WILLIAM COLLARD, COLLARD & ROE, P.C., 1077 NORTHERN BOULEVARD, ROSLYN, NY, 11576, US

(21) Appl. No.: 10/149,801

(22) PCT Filed: Dec. 9, 2000
(86) PCT No.: PCT/EP00/12466

(30) Foreign Application Priority Data
Dec. 14, 1999 (DE) 19960370.7

(51) Int. Cl. G01K 11/26

(52) U.S. Cl. 374/118; 374/117; 374/161

(57) ABSTRACT

The invention relates to a fiber-optic temperature sensor which is provided with a preferably spherical microparticle with a diameter in the range of from 5 to 100 micrometers as the optical resonator. Said microparticle is linked with optical waveguides for coupling light in or out. A laser diode (1) incites optical resonances in the microparticle, the wavelengths of these resonances depending on the diameter of the microparticle. Due to the thermal expansion of the microparticle, said diameter in turn depends on the temperature. The temperature sensor is calibrated so that the resonance wavelengths can be correlated with corresponding temperature values.

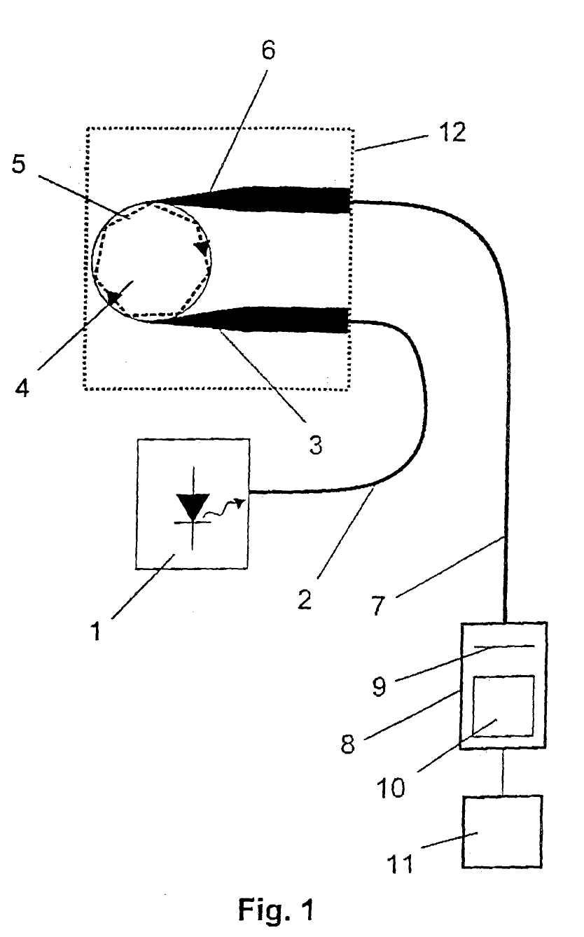

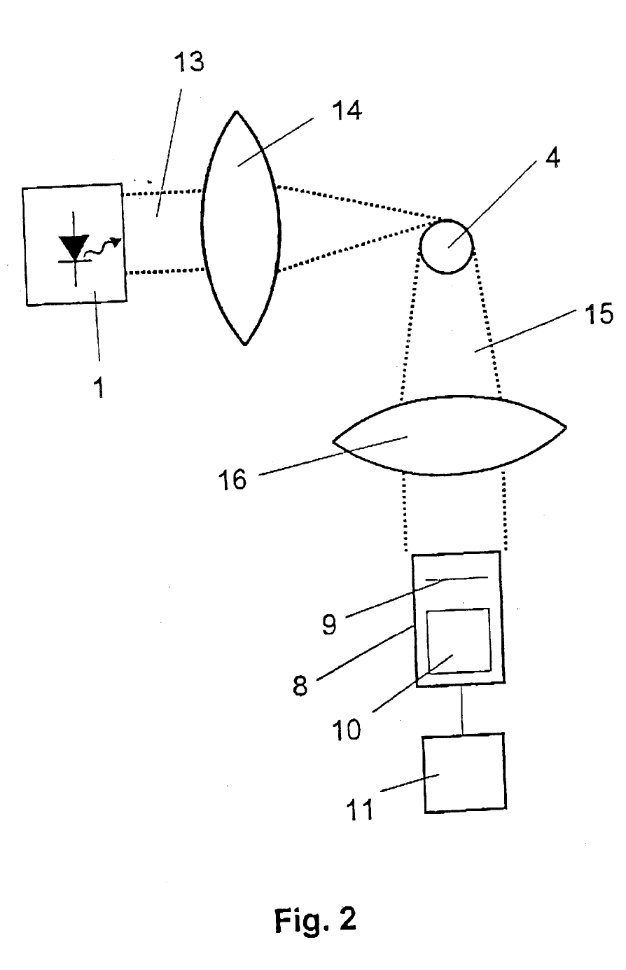

The present invention relates to a temperature sensor comprising an optical resonator that is connected to one or more light wave conductors.

A whole series of different temperature sensors is known and is finding wide use to some extent. For example, thermoresistors are known in connection with which a temperature-dependent ohmic resistance is employed for determining the temperature, or thermoelements are used that consist of two different metals, the contact voltage of which is depending on the temperature. The known temperature sensors have the drawback that they do not reliably function in environments with strong electromagnetic interference fields.

DE 197 38 651 discloses a fiber-optical temperature sensor, in which the optical fiber is embedded between two foils. The dependence of the optical properties of glass on temperature are used in the measurement of the temperature. In this case, the glass fiber itself is the actual temperature sensor. The known temperature sensor is suited for measuring the surface temperature of an object. The sensor has a measuring surface area with a size of several square centimeters. The surface temperature is averaged across said measuring surface area. This limits the applicability of the known temperature sensor to measuring surface temperatures of large surface areas.

The present invention is based on the problem of providing a temperature sensor with high resolution that has extremely small geometric dimensions and, in this way, permits temperature measurements with high resolution in terms of space also in areas that are difficult to access. The temperature sensor is expected to reliably function irrespectively of electromagnetic interference fields.

Said problem is solved in connection with a temperature sensor of the type specified above in that a micro-particle is used to serve as the optical resonator, whereby the light of a laser diode is coupled into the micro-particle via the ends of the light wave conductors, said ends being shaped into thin tips, on the one hand, and the light is decoupled from the micro-particle by means of an optical spectrometers for the evaluation, on the other hand.

In the micro-particle as defined by the invention, optical resonances are generated in the presence of light wave lengths that depend on the geometric shape and dimensions of the micro-particle. In this connection, the light is totally reflected several times on the inner surface of the micro-particle. If such multiple reflection leads to phase-correct superimposition of the wave trains of the electromagnetic field, this is referred to as an optical resonance. An excessive rise of the amplitude of the electromagnetic field occurs in this connection in the interior of the micro-particle. In the total reflection, which occurs during the transition from the optically denser medium of the micro-particle to the optically thinner environment, the losses are low, so that it is possible to realize in this way a resonator with a particularly high quality. This leads to the development of pronounced, narrow-banded resonances in the presence of characteristic wavelengths.

Conditioned by the thermal coefficient of expansion of the material from which the micro-particle as defined by the invention is produced, the resonance properties of the optical resonator are dependent upon the temperature of the environment in which the micro-particle is located. The index of refraction of the resonator medium, which may have some dependency on the temperature as well, exerts an additional influence that cannot be neglected.

According to the invention, the light of a laser diode is used for stimulating the resonances. This offers the advantage that such a laser diode is freely available commercially as a reasonably priced component, and that a suitable wide-banded, coherent stimulating radiation can be generated with such a laser diode.

The use of the micro-particle as defined by the invention as a temperature sensor is feasible in practical life only if the transmission of the light to the resonator is interference-proof, and if the light is coupled into the resonator with low losses at the same time. These requirements are satisfied by employing light wave conductors for transmitting the light. At the same time, the flexible optical fibers make it possible to mount the temperature sensor in locations that are difficult to access.

For measuring the temperature, it is necessary to determine the wavelengths of the stimulated resonances. For this purpose, the light is decoupled again from the optical resonator by means of a light wave conductor and supplied to a suitable spectrometer.

Micro-particles that are suitable for use as a temperature sensor as defined by the invention have diameters of 100 microns or less. Commercially available light conductor fibers with a diameter of from 80 to 125 microns are unsuitable for coupling the light in and out. The ends of the light wave conductors that are connected with the optical resonator are shaped for that reason into thin tips, so that the fibers are tapering down to just a few microns. It was found in experiments that such tips of the fibers possess an ideal radiation characteristic for coupling the light into the optical resonator. The same, of course, applies to decoupling the light as well, which is required for the spectroscopic examination of the resonances. The small dimensions of the micro-particle as defined by the invention, in combination with the aforementioned advantageous properties of the light wave conductors employed, leads to the fact that the temperature sensor is capable of solving the problem on which it is based to a particularly high degree.

The micro-resonator is usefully produced from an UV-curing polymer material. In this production, a fluid starting material, the viscosity of which may be reduced by adding a highly volatile solvent, is atomized to fine droplets. A rapid polymerization reaction is initiated by UV-irradiation, which causes the small droplets to cure to the desired photopolymer micro-particles in the shortest possible time. The micro-particles produced according to this method have an almost ideal spherical shape with diameters ranging from 10 to 100 microns. Furthermore, the photopolymer material has ideal optical properties for employing it as a micro-resonator. The material is homogeneous and transparent, which is an important precondition to be met for a resonator of high quality. The index of refraction is between 1.5 and 1.6. Thus a total reflection can be achieved on the inner surface of the micro-particles with no problems.

If the temperature sensor is to be employed for measuring temperatures amounting to a few hundred degrees, the photopolymer mentioned above is unsuitable. In this case, micro-particles made of quartz glass are usefully employed. This material has a high index of refraction as well and is capable of easily withstanding temperatures of up to 900° C.

As stated above, the wavelengths of the occurring optical resonances are determined for measuring the temperature. So as to be able to stimulate a defined resonance, the light of the corresponding wavelength has to be generated first. This can be accomplished either with the laser-diode, the emission spectrum of which contains light having a suitable wavelength, or by means of fluorescent light that is generated only in the micro-particle. The starting material of the micro-particle has to be doped for this purpose with fluorescent dyestuff. The dyestuff is stimulated to fluorescence by the laser diode. The wide fluorescence spectrum of the dyestuff is capable of stimulating optical resonances in the micro-particle. These resonances can be detected by means of the optical spectrometer. The commonly available fluorescence dyestuffs such as, for example Rodamin 6g or DCM, can be considered for practical applications. Their limited useful life, however, represents a drawback. The use of rare earths such as, for example neodymium, as it is used in solid lasers, represents an alternative.

The problem arising in the production of the temperature sensor as defined by the invention is that the micro-resonator has to be connected with the light wave conductors without substantially deteriorating the resonance properties. It was found to be useful to employ for this purpose a photopolymer adhesive. This is a material that is similar to the one that can be used also for producing the micro-particles described above. The ends of the tips of the light wave conductors are first placed in the desired position on the micro-particles. The points of connection are wetted with the liquid photopolymer and cured by means of UV-radiation. It is easily possible to select for the adhesive a photopolymer with an index of refraction lower than the one of the optical resonator. This is a precondition that has to be met to allow total reflection to occur in the interior of the micro-particle.

In connection with the optical resonator as defined by the invention, it is advantageous to its practical application as a temperature sensor if the occurring optical resonances can be resolved without problems by means of the optical spectrometer and separated from each other. When using visible light for stimulating the resonances, this is the case if the spherical micro-particle has a diameter of from 5 to 100 microns.

Experiments have shown that in particular surface resonances of the spherical micro-particle are suited for measuring the temperature. Such surface resonances can be effectively stimulated by coupling the light in tangentially along the peripheral edge of the sphere.

For the actual temperature measurement, a temperature is allocated in the optical spectrum to the resonance wavelengths. In fact, an exact theory exists for spherical micro-particles that would allow to draw conclusions from the optical spectrum with respect to the particle diameter. However, a calibration has been successfully used in practical applications for the temperature measurement. In such a calibration, the resonance spectrum of the optical resonator is recorded at different, precisely known temperatures. The actual temperature measurement is then carried out by means of the temperature sensor as defined by the invention by means of interpolation between the temperature values used for the calibration.

The temperature measurement is the more accurate the more resonances can be stimulated in the micro-particle. It is therefore useful if the laser diode is operated in such a way that the stimulating light has a large spectral width. Experiments have shown that a broad emission spectrum can be generated with a multi-mode laser diode; however, such a broad spectrum consists of a multitude of discrete wavelengths. In unfavorable cases, only a few resonances can be generated even with such a stimulation spectrum. However, it is possible to employ the laser diode in a mode of operation in which no laser emission will start as yet. The spectrum has in this connection an almost homogeneously broad emission that is ideally suited for stimulating as many resonances of the micro-particle as possible.

Owing to the fact that the resonance spectrum of the optical resonator is determined by the shape of the microparticle, the temperature sensor reacts with extreme sensitivity on forces even if such forces deform the microparticle only to a minimal extent. Therefore, for practically using it as a temperature sensor under rough conditions, it is useful to accommodate the micro-particle in a mechanically stable cover. For example, a stable glass capillary that accommodates the micro-particle together with the light wave conductors is suited for said purpose. For conducting heat, the glass capillary may be filled with a fluid with an index of refraction that has to be lower than the one of the micro-particle.

Forces acting on the micro-particle lead to deformations and, as stated above, to a change in the resonance spectrum. This property can be advantageously exploited for using the optical micro-resonator embedded in workpieces for detecting material stresses.

Furthermore, the optical micro-resonator as defined by the invention can be advantageously employed as an approximation sensor as well. When the optical resonator is stimulated to generating a resonance, an evanescent electrical field exists in its direct environment. When this field comes into contact with material in the environment of the micro-particle, the electromagnetic field in the interior of the micro-particle and thus the resonance spectrum are influenced as well. Therefore, it is conceivable to use the optical micro-resonator as defined by the invention for scanning, for example surfaces with a resolution of just of few nanometers.

An exemplified embodiment of a temperature sensor as defined by the invention is explained in the following with the help of the drawing.

The light of a laser diode 1 is tangentially coupled into a spherical micro-particle 4 via a light wave conductor 2, the end of which is shaped into a conical tip 3. Through multiple total reflections, a surface resonance is developed on the inner interface of the micro-particle 4. The path of the waves of such surface resonance is indicated by the dashed line 5. For decoupling the light, the tip 6 of another light wave conductor 7 is located on the opposite side of the micro-particle 4. The decoupled light is spectroscoped in an optical spectrometer 8 that is comprised of a diffraction grating 9 and a CCD-camera 10. The resonance spectrum is converted by calculation into a temperature value by means of an evaluation electronics unit 11. The dashed square 12 indicates that the fiber tips 3 and 6 as well as the micro-particle 4 are shown enlarged in an overproportional way. The diameter of the micro-particle 4 amounts to about 30 microns; the fiber tips 3 and 6 are tapering down to about 1 micron.

1. A temperature sensor with an optical resonator connected with one or more light wave conductors (2, 7), characterized in that a micro-particle (4) is employed serving as the optical resonator, whereby on the one hand, the light of a laser diode (1) is coupled into the microparticle (4) via the ends of the light wave conductors (2, 7), said ends being shaped into thin tips (3, 6), and, on the other hand, the light is decoupled from the microparticle (4) for the evaluation by means of an optical spectrometer (8).

2. The temperature sensor according to claim 1, characterized in that the micro-particle (4) consists of a polymer material curing under UV-light.

3. The temperature sensor according to claim 1, characterized in that the micro-particle (4) consists of quartz glass.

4. The temperature sensor according to at least one of claims 1 to 3, characterized in that the starting material of the micro-particle (4) is doped with fluorescent dyestuff.

5. The temperature sensor according to at least one of claims 1 to 4, characterized in that the ends (3, 6) of the tips of the light wave conductors (2, 7) are glued to the micro-particle (4), whereby the index of refraction of the adhesive is lower than the one of the micro-particle (4).

6. The temperature sensor according to at least one of claims 1 to 5, characterized in that the micro-particle (4) is spherical and has a diameter of from 5 to 100 microns.

7. The temperature sensor according to claim 6, characterized in that the light from the light wave conductor (2) is tangentially coupled into the spherical micro-particle (4).

8. The temperature sensor according to at least one of claims 1 to 7, characterized in that the resonance wavelengths determined by means of the optical spectrometer (8) are allocated to a temperature value by a calibration.

9. The temperature sensor according to at least one of claims 1 to 8, characterized in that the laser diode (1) is operated in such a manner that it emits light with a large spectral width.

10. The temperature sensor according to at least one of claims 1 to 9, characterized in that the micro-particle (4) is arranged in a mechanically stable cover.

11. Application of an optical micro-resonator for determining material stresses.

12. Application of an optical micro-resonator as an approximation sensor.
